(19) United States
(12) Patent Application Publication
(10) Pub. No.: US 2007/0194224 A1
(43) Pub. Date: Aug. 23, 2007

(54) Monolithic electrospray ionization emitters and methods of making same

(75) Inventors: Keqi Tang, Richland, WA (US); Jason S. Page, Kennewick, WA (US); Quanzhou Luo, Richland, WA (US); Richard D. Smith, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 11/346,799

(22) Filed: Feb. 2, 2006

(51) Int. Cl. H01J 49/10

(52) U.S. Cl. 250/288

(57) ABSTRACT

Electrospray ionization (ESI) apparatuses and methods of making the same are disclosed. In one embodiment, an ESI emitter comprises a capillary tube filled with a porous monolithic material, wherein the end of the emitter is tapered and the tip of the tapered end comprises a protrusion of the porous monolithic material. One embodiment of the method for making ESI emitters comprises filling a capillary tube with a porous monolithic material and tapering the end of the capillary tube, thereby exposing a portion of the porous material. The exposed portion of the porous material at the tapered end, rather than the capillary tube itself, forms the tip of the ESI emitter.

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### BACKGROUND

Electrospray ionization (ESI) methods and apparatuses, which can be coupled with separation techniques such as liquid chromatography (LC), have helped to make mass spectrometry (MS) one of the most important tools in proteomic studies. However, a common problem associated with ESI-MS is reoccurring clogging of the emitter due to the requirement for an ultra fine diameter emitter tip. Therefore, a need exists for a robust ESI emitter that resists clogging and a method of making the same.

### DESCRIPTION OF DRAWINGS

Embodiments of the invention are described below with reference to the following accompanying drawings.

FIG. 1 is an illustration of an embodiment of an ESI emitter showing a cutaway view of the tapered end.

FIG. 2 is an illustration of an embodiment of a monolithic LC-ESI device.

FIG. 3 is an illustration of an embodiment of a modular LC-ESI device.

FIG. 4 is an illustration of an embodiment of a pseudo-monolithic LC-ESI device.

FIG. 5 mass spectra of two different test solutions acquired from a traditional pulled capillary ESI emitter and a monolithic ESI emitter embodying the present invention.

### DETAILED DESCRIPTION

Aspects of the present invention relate to apparatuses and methods for electrospray ionization. In one embodiment, the ESI emitter comprises a capillary tube filled with a porous monolithic material. The end of the emitter is tapered and the tip of the tapered end comprises a protrusion of the porous monolithic material. Another embodiment encompasses a method for making ESI emitters. The method comprises filling a capillary tube with a porous monolithic material and tapering the end of the capillary tube, thereby exposing a portion of the porous material. The exposed portion of the porous material at the tapered end, rather than the capillary tube itself, forms the tip of the ESI emitter.

FIG. 1 is an illustration of an embodiment of an ESI emitter. The tapered end 100 is drawn from a cutaway view to show the tip 101, which is composed of a porous monolithic material 102. The outer diameter 105 near the tapered end 100 can be tapered to match the tapered shape of the tip 101. The tapered end can be made by mechanically or chemically removing portions of the filled capillary tube and the porous monolithic material.

The capillary tube 104 can comprise, for example, fused silica or plastic. By way of example, and not limitation, the porous monolithic material 102 can be mesoporous and/or it can comprise silica, a polymer, or a combination thereof. Furthermore, when the ESI emitter will be used with separations techniques, for example, LC separations, the porous monolithic material 102 can be chemically modified to complement those techniques. For example, the surface of a mesoporous silica monolithic material can be modified by attaching different functional groups thereto that would match different packing materials relevant to various LC separation methods.

In one embodiment, the inner diameter 103 of the capillary tube is substantially constant through the axial length of the ESI emitter. More specifically, there is no reduction in the inner diameter 103 at the tapered end 100. The inner diameter 103 can be less than or equal to approximately 150 micrometers. In a specific instance, the inner diameter 103 can be approximately 10 micrometers.

The constant inner diameter described by the present embodiment contrasts with many of the currently available ESI emitters, which exhibit a significant reduction in inner diameter at the end of the emitter. Such reduction in inner diameter can be a result of the manner in which the ESI emitter tip is formed. For example, one common method of forming ESI emitter tips is laser pulling, wherein the capillary tube is heated by laser and then pulled to cause the heated region to constrict. Accordingly, both the outer diameter and the inner diameter of laser-pulled capillary tubes might be reduced during formation of the tip.

In one embodiment, the ESI emitter interfaces a LC separations column. The LC separations column can comprise a packing for multi-dimensional or single-dimensional separations. Examples of packing materials for multi-dimensional or single dimensional separations can include, but are not limited to materials for normal phase separations, reverse phase separations, strong cation exchange separations, and solid phase extraction.

In one variation of the present embodiment, the ESI emitter can be an integrated part of a monolithic LC-ESI device. Referring to FIG. 2, an embodiment of a monolithic LC-ESI device comprises a LC separations column region 201 with an integrated ESI emitter region 202. The porous monolithic material 102 forming the tip 101 in the ESI emitter is substantially the same material used for the packing in the LC separations column region. Monolithic LC-ESI devices can be made by fabricating the ESI emitter and tip directly on a monolithic LC separations column.

In another variation, the ESI emitter is a discrete part of a modular LC-ESI device comprising the ESI emitter and a LC separations column connected by a joint. Referring to FIG. 3, an embodiment of the modular LC-ESI device comprises a LC separations column 301 and an ESI emitter 302 that are discrete components connected by a joint 303. The porous monolithic material 102 forming the tip 101 in the ESI emitter component 302 can be substantially the same material used for the packing 304 in the LC separations column component or it can be different. In some instances, a retaining material 305, for example, a frit, can be used to retain the packing 304 in the LC separations component and prevent the packing from entering the ESI emitter component. Alternatively, the porous monolithic material 102 can serve retain the packing 304.

In yet another variation, the ESI emitter can be an integrated part of a pseudo-monolithic LC-ESI device. Referring to FIG. 4, an embodiment of the pseudo-monolithic LC-ESI device comprises a LC separations column region 401 having a packing 403 of a first composition and an integrated ESI emitter region 402 having a porous monolithic material 102 of a second composition. Specifically, the porous monolithic material 102 forming the tip 101 in the ESI emitter region has a different composition than the material used for the packing 403 in the LC separations column region. In pseudo-monolithic LC-ESI devices, as in modular LC-ESI devices, the monolithic porous material 102 of the ESI emitter region 402 can serve to retain the packing material 403 in the LC separations region 401 at the interface 404 of the LC-ESI device. Alternatively, a retaining material can be placed at the interface 404 to separate the packing material 403 and the porous monolithic material 102.

### EXAMPLE

Fabrication of Monolithic LC-ESI Device

The present example describes the fabrication of a silica-based LC separations column having an integrated ESI emitter. It is included for illustrative purposes and should not be interpreted as a limitation to the scope of the present invention.

The LC separations column was prepared in a pretreated fused-silica capillary tube. Approximately 0.88 g of Polyethylene glycol (PEG) and 0.9 g of urea were dissolved in 10 mL of 0.01 mol/L acetic acid. Tetramethoxysilane was added to the solution and the resultant homogeneous mixture was pressured into the capillary tube. The mixture was allowed to react in the tube for 20 hours at approximately 30° C. The silica monolithic column was then treated with ammonia generated by the hydrolysis of the urea at 120° C. for 3 hours to form mesopores. After thermal treatment of the column at 330° C. for 25 hours, surface modification was carried out on-column by continuously feeding a solution of n-octadecyltriethoxysilane in toluene (10% V/V) at 110° C. overnight. As a final step hexamethyldisilazane solution (20% dichloromethane) was pressured into the column and reacted at 160° C. for 3 hours to block the unreacted silanol groups. After washing with excessive toluene followed by acetonitrile, the monolithic column was ready for use in LC separations.

An ESI emitter was fabricated directly on one end of the monolithic column, eliminating the need for traditional junctions between discrete LC columns and ESI emitters. First, a small section (approximately 0.5 cm) of the polyimide coating was removed from the end of the column with a butane torch. The column was held by threading the opposite end through a stainless steel union and clamping it to the union using a peek fitting. The union allowed for easier handling during the tip fabrication and also as a means to secure the exit of the monolithic column during the subsequent characterization experiments by LC-mass spectrometry. A rotary tool with a polishing bit was used to mechanically taper the column tip. To perform the tapering, the end of the column was lowered onto the rotating polishing bit and the slowly turned to provide even removal of the silica from the tip.

### EXAMPLE

Characterization of the ESI Emitters

The electrospray performance of the tapered emitter of the monolithic column was compared to that of a traditional pulled capillary emitter. Based on the ESI current dependence on the flow rate, the monolithic emitter produced electrosprays with a stability and performance similar to those from a pulled capillary described by Fernandez de la Mora and Loscertales. Since the monolithic emitter gave currents that correspond well to the relationship established by Fernandez de la Mora and Loscertales (Fernandez de la Mora, J.; Loscertales, I. G. J. Fluid Mech. 1994, 260, 155-184), wherein the electrospray current is proportional to the square root of the flow rate through the emitter, it appears that the monolithic emitter produced single cone jet sprays.

The performance of the monolithic emitter was further evaluated by comparing the MS spectra from a monolithic emitter to those from a traditional pulled tip emitter. Referring to FIG. 5, mass spectra were acquired on a single quadrupole mass spectrometer using two different sample mixtures. Spectra 501 and 502 were obtained from the pulled capillary emitter with 1) an Agilent tuning/calibration mix (U.S. Pat. No. 5,872,357) in pure acetonitrile and 2) a solution with caffeine, MRFA peptide, and reserpine in a 50:50 methanol and water mixture, respectively. The measurement was then repeated using the monolithic emitter and the same two solutions 503 and 504, respectively. For both solutions, the tapered monolithic emitter performed similarly to the traditional pulled capillary emitter. Accordingly, the tapered monolithic emitter, as well as the various embodiments described and/or claimed herein, is a robust emitter exhibiting sufficient performance and reduced clogging for ESI applications.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. An electrospray ionization (ESI) emitter comprising a capillary tube filled with a porous monolithic material, wherein the end of the emitter is tapered and the tip comprises a protrusion of the porous monolithic material.

2. The ESI emitter as recited in claim 1, wherein the inner diameter of the capillary tube is less than or equal to approximately 150 micrometers.

3. The ESI emitter as recited in claim 1, wherein the inner diameter of the capillary tube is approximately 10 micrometers.

4. The ESI emitter as recited in claim 1, wherein the inner diameter of the capillary tube is substantially constant through the axial length of the ESI emitter.

5. The ESI emitter as recited in claim 1, wherein the porous monolithic material comprises silica.

6. The ESI emitter as recited in claim 1, wherein the porous monolithic material comprises a polymer.

7. The ESI emitter as recited in claim 1, wherein tapered end of the ESI emitter is mechanically or chemically fabricated.

8. The ESI emitter as recited in claim 1, wherein the ESI emitter interfaces a LC separations column, thereby forming an LC-ESI device.

9. The ESI emitter as recited in claim 8, wherein the LC separations column comprises a packing for multi-dimensional or single dimensional separations.

10. The ESI emitter as recited in claim 1, wherein the ESI emitter is an integrated part of a monolithic LC-ESI device.

11. The ESI emitter as recited in claim 10, wherein the porous monolithic material is chemically modified for liquid chromatography (LC) separations.

12. The ESI emitter as recited in claim 1, wherein the ESI emitter is a discrete part of a modular LC-ESI device comprising the ESI emitter and a LC separations column connected by a joint.

13. The ESI emitter as recited in claim 1, wherein the ESI emitter is an integrated part of a pseudo-monolithic LC-ESI device.

14. The ESI emitter as recited in claim 13, wherein the porous monolithic material retains, in part, a packing material in an LC separations region of the pseudo-monolithic LC-ESI device.

15. A method of making an ESI emitter comprising filling a capillary tube with a porous monolithic material and tapering the end of the filled capillary tube, thereby exposing a portion of the porous monolithic material, wherein the exposed portion of the porous monolithic material forms a tip.

16. The method as recited in claim 15, wherein the porous monolithic material comprises a mesoporous material.

17. The method as recited in claim 15, wherein the inner diameter of the capillary tube is less than or equal to approximately 150 micrometers.

18. The method as recited in claim 15, wherein the inner diameter of the capillary tube is approximately 10 micrometers.

19. The method as recited in claim 15, wherein the inner diameter of the capillary tube is substantially constant through the axial length of the ESI emitter.

20. The method as recited in claim 15, wherein said tapering comprises mechanically or chemically removing portions of the filled capillary tube and the porous monolithic material.
